(19) United States
(12) Patent Application Publication
(10) Pub. No.: US 2006/0226188 A1
(43) Pub. Date: Oct. 12, 2006

(54) Vehicle accessory mounting structure

(75) Inventor: Michael Smith, Highland, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/094,480

(22) Filed: Mar. 31, 2005

(51) Int. Cl. B60R 9/00

(52) U.S. Cl. 224/326; 224/557

(57) ABSTRACT

A vehicle accessory mounting structure is described herein that includes a vehicle body panel, a mounting fastener and a sealing washer. The vehicle body panel has exterior and interior sides with a fastener receiving opening extending therebetween. The mounting fastener extends between the exterior side of the vehicle body panel and the interior side of the vehicle body panel. The sealing washer includes a tubular portion, a rigid annular flange portion and a compressible sealing material. The tubular portion is disposed about the shaft portion of the mounting fastener. The rigid annular flange portion extends radially from the tubular portion. The compressible sealing material is disposed between the vehicle body panel and the rigid annular flange portion with at least a portion of the compressible sealing material being compressed into the fastener receiving opening when the mounting fastener is tightened.

### BACKGROUND OF THE INVENTION

1. Field of the Invention

The present invention generally relates to a vehicle accessory mounting structure. More specifically, the present invention relates to a vehicle accessory mounting structure that secures a vehicle accessory component to a vehicle body panel such that the ingress of water and/or other contaminants is prevented through a fastening point of the vehicle accessory mounting structure.

2. Background Information

Many vehicles are equipped with accessories that are mounted to an exterior surface of the vehicle. Such accessories include roof racks, spare tire mounting structures, bicycle racks and the like. These accessories are usually installed using an accessory mounting structure having fasteners that extend through apertures formed in an accessory mounting portion (e.g., roof rack, etc.) and into apertures formed in an outer body panel of the vehicle. Typically, it is common in these conventional accessory mounting structures to have a reinforcement plate as the primary mounting structure that lies beneath an outer body panel. A conventional seal member is usually disposed between the accessory mounting portion and the head of each of the fasteners, which are typically designed to provide a seal between an outer periphery of the accessory mounting portion and the head of each of the fasteners Moreover, a gasket is typically installed between the accessory mounting portion and the outer body panel of the vehicle to provide a seal therebetween. However, with these conventional accessory mounting structures there is a potential for misalignment of the fastener apertures in the outer body panel and the reinforcement plate.

While the conventional seal member typically limits the ingress of water and debris between the accessory and the outer body panel of the vehicle, these conventional seal member typically does not usually provide a seal for the aperture the outer body panel or around the fastener when the fastener apertures in the outer body panel and the reinforcement plate do not align sufficiently. As a result, it may be possible for water to travel pass the fastener, pass the accessory mounting portion (e.g., roof rack, etc.) and into the aperture in the outer body panel and into the cabin of the vehicle.

In view of the above, it will be apparent to those skilled in the art from this disclosure that there exists a need for an improved vehicle accessory mounting structure. This invention addresses this need in the art as well as other needs, which will become apparent to those skilled in the art from this disclosure.

### SUMMARY OF THE INVENTION

It has been discovered that the conventional sealing structure for the above mentioned accessory mounting structures sometimes leaks due to the large assembly variation in the alignment of the fastener apertures in the outer body panel and the reinforcement plate. Thus, an additional seal is necessary in order to reliably prevent the ingress of water along the mounting fasteners of the vehicle accessory and/or in the area around the fastener apertures in a vehicle body panel that receives the mounting fasteners.

One object of the present invention is to provide a vehicle accessory mounting structure with a simple sealing structure that forms a water tight seal between a vehicle accessory mounted to an outer body panel of a vehicle.

Another object of the present invention is to provide a vehicle accessory mounting structure with a simple sealing structure that allows for variations in manufacturing tolerances in vehicle construction and provides a reliable seal between a vehicle accessory mounted to a vehicle and an outer body panel of the vehicle.

In accordance with one aspect of the present invention, a vehicle accessory mounting structure includes a vehicle body panel, a mounting fastener and a sealing washer. The vehicle body panel has an exterior side and an interior side with a fastener receiving opening extending between the exterior and interior sides. The mounting fastener includes a shaft portion, an exterior retaining portion and an interior retaining portion. The shaft portion is disposed in the fastener receiving opening. The exterior retaining portion is disposed on the exterior side of the vehicle body panel. The interior retaining portion is disposed on the interior side of the vehicle body panel. The sealing washer includes a tubular portion, a rigid annular flange portion and a compressible sealing material. The tubular portion is disposed about the shaft portion of the mounting fastener. The rigid annular flange portion extends radially from the tubular portion. The compressible sealing material is disposed between the vehicle body panel and the rigid annular flange portion with at least a portion of the compressible sealing material being compressed into the fastener receiving opening when the mounting fastener is tightened.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a side elevational view of a vehicle that includes a vehicle accessory mounting structure in accordance with the present invention;

FIG. 2 is a fragmentary top plan view of the vehicle depicted in FIG. 1 showing an accessory (roof rack) installed on the roof of the vehicle using the vehicle accessory mounting structure in accordance with the present invention;

FIG. 3 is a fragmentary perspective view of the vehicle depicted in FIG. 1 showing a portion of the accessory mounted to the roof of the vehicle in accordance with the present invention;

FIG. 4 is an enlarged fragmentary perspective view of a mounting portion of the accessory installed on the vehicle, showing selected details of the vehicle accessory mounting structure in accordance with a first embodiment of the present invention;

FIG. 5 is a fragmentary side elevational view of the mounting portion of the accessory, showing further details of the vehicle accessory mounting structure in accordance with the first embodiment of the present invention;

FIG. 6 is an enlarged cross sectional view of a portion of the mounting member depicted in FIG. 5, showing details of the vehicle accessory mounting structure in accordance with the first embodiment of the present invention;

FIG. 7 is an exploded cross sectional view of the portion of the mounting member depicted in FIG. 6, showing details of the vehicle accessory mounting structure of the mounting member in accordance with the first embodiment of the present invention;

FIG. 8 is an exploded top perspective view of the sealing washer of the vehicle accessory mounting structure shown in accordance with the first embodiment of the present invention;

FIG. 9 is an exploded bottom perspective view of the sealing washer depicted in FIG. 8 in accordance with the first embodiment of the present invention;

FIG. 10 is an enlarged cross sectional view of a portion of the mounting member similar to FIG. 6, showing details of a vehicle accessory mounting structure in accordance with a second embodiment of the present invention;

FIG. 11 is an exploded cross sectional view of the portion of the mounting member depicted in FIG. 10 showing details of the vehicle accessory mounting structure in accordance with the second embodiment of the present invention;

FIG. 12 is an exploded top perspective view of the sealing washer of the vehicle accessory mounting structure depicted FIGS. 10 and 11 in accordance with the second embodiment of the present invention;

FIG. 13 is an exploded bottom perspective view of the sealing washer shown in FIG. 12 in accordance with the second embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

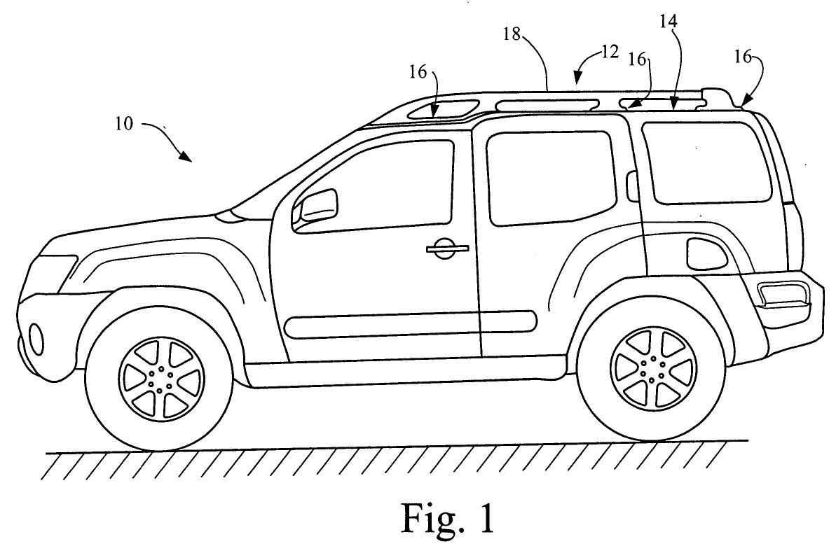

Referring initially to FIG. 1, a vehicle 10 is illustrated that is equipped with a vehicle accessory 12, which is fixedly attached to a roof structure 14 of the vehicle 10 by a vehicle accessory mounting structure 16 in accordance with a first embodiment of the present invention. The vehicle 10 basically includes the roof structure 14 and other conventional structures and elements whose descriptions are omitted for the sake of brevity. In other words, only the portions of the roof structure 14 which relate to the present invention will be discussed herein.

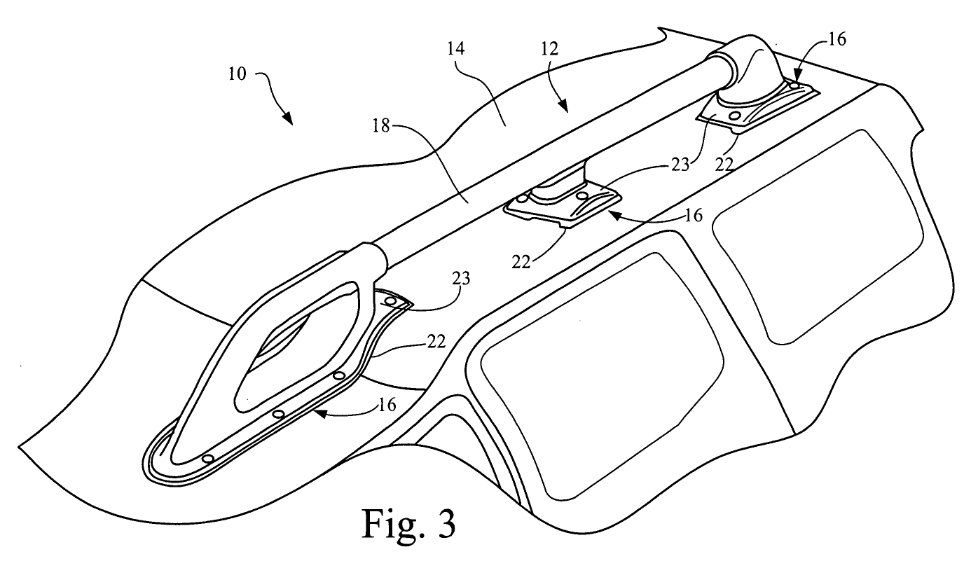

In the first embodiment of the invention, the vehicle accessory 12 is depicted as a pair of roof racks 18 that are mounted to the roof structure 14 of the vehicle 10 by the vehicle accessory mounting structure 16, as shown in FIGS. 1, 2 and 3. As should be apparent from the drawings and description herein, the vehicle accessory mounting structure 16 is not limited for use with the depicted roof racks 18. For example, the vehicle accessory 12 can be any of a variety of accessories mounted on the vehicle 10, such as a bicycle rack, a spare tire rack or other vehicle similar accessories that are fixedly attached to the vehicle 10.

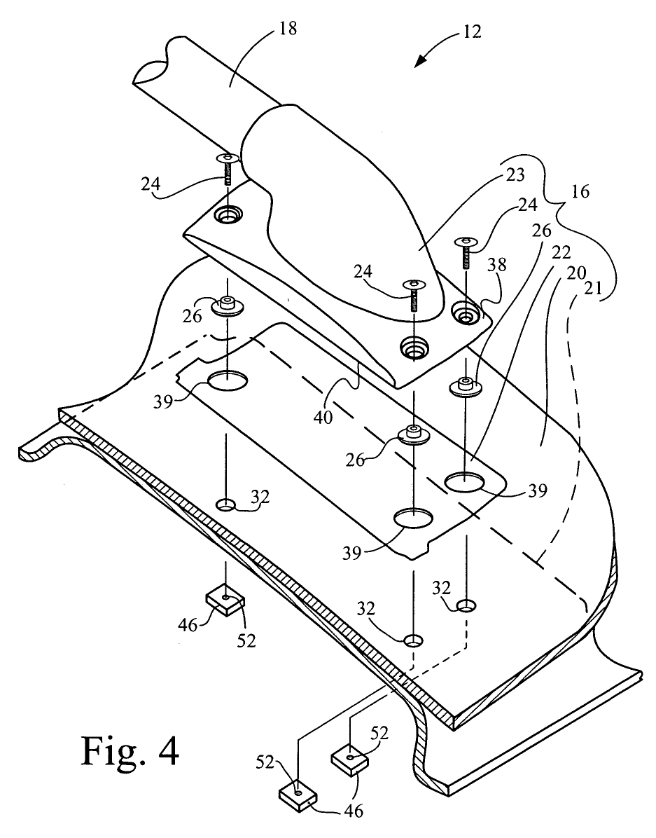

In the case of the roof racks 18, three mounting points are provided for each roof rack 18. Thus, three vehicle accessory mounting structures 16 are formed between each of the roof racks 18 and the roof structure 14. As best shown in FIGS. 4, 5 and 6, each of the vehicle accessory mounting structures 16 basically includes a vehicle body panel 20 (part of the roof structure 14), a reinforcement or support member 21 (part of the roof structure 14), a cushioning seal or gasket 22, an accessory mounting member 23 (part of the roof racks 18), a plurality of mounting fasteners 24 and a plurality of sealing washers 26. The vehicle accessory mounting structure 16 is arranged and configured to couple the vehicle accessory 12 (roof racks 18) to the vehicle body panel 20 and the support member 21 using the mounting fasteners 24. The sealing washers 26 are at least partially disposed between a portion of the accessory mounting member 23 and the vehicle body panel 20 for providing a water tight seal between the mounting fasteners 24 and the vehicle body panel 20, as described in greater detail below.

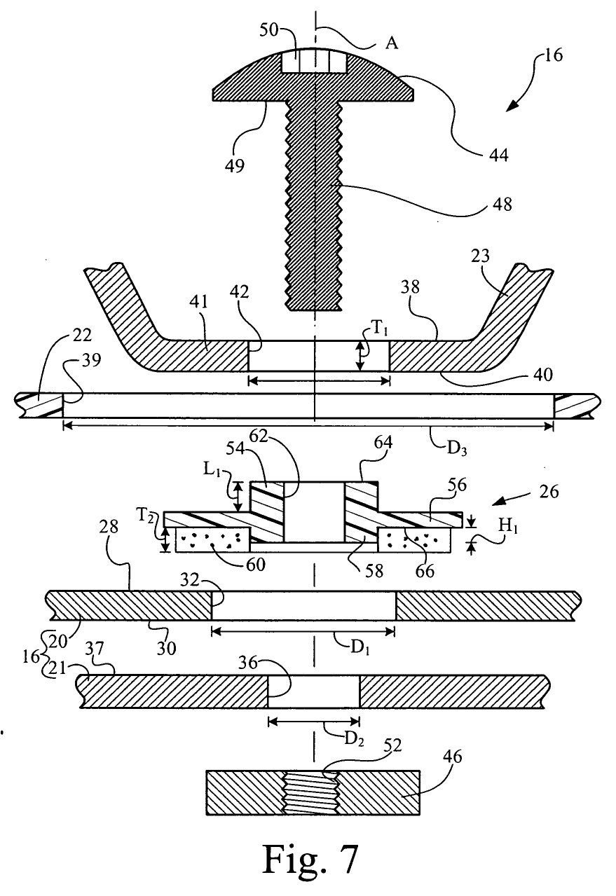

In the first embodiment of the present invention, the vehicle body panel 20 is preferably a portion of the roof structure 14 but can alternatively the present invention be applied to other portions of the vehicle 10 where a vehicle accessory is to be mounted. As best shown in FIG. 7 the vehicle body panel 20 basically includes an exterior side 28, an interior side 30, and a plurality of fastener apertures 32. Each aperture 32 forms a fastener receiving opening that extends between the exterior side 28 and the interior side 30 and has a diameter D₁.

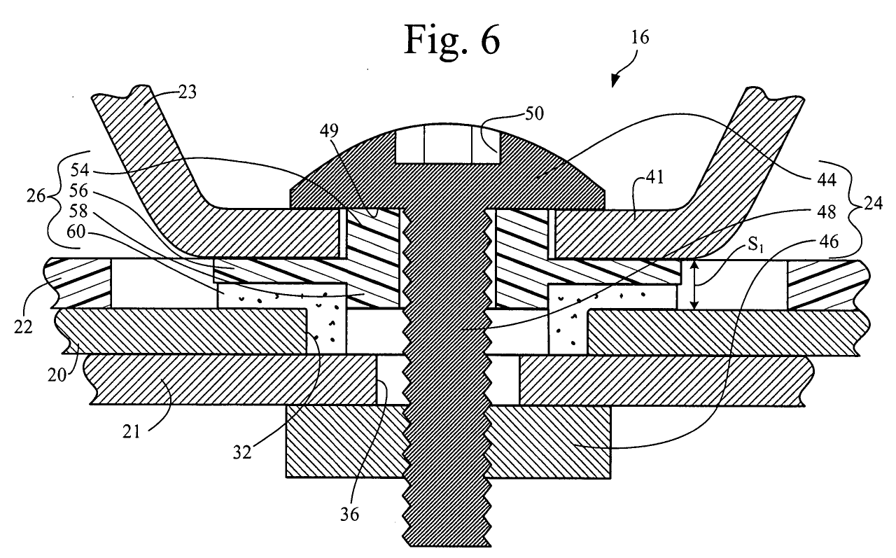

The support member 21 is typically a cross member that extends from side-to-side within the vehicle 10 as part of the roof structure 14. However, it should be understood from the drawings and the description of the invention that the support member 21 can also be a non-roof related support bracket positioned on the interior side 30 of the vehicle body panel 20 providing additional support for attachment of the vehicle accessory 12. The support member 21 is formed with a plurality of fastener apertures 36 (FIG. 6), each having a diameter D₂. The support member 21 also has an upper surface 37 that is at least partially exposed through the apertures 32 of the vehicle body panel 20, as explained in greater detail below.

The apertures 36 are preferably approximately aligned with the apertures 32 in the vehicle body panel 20. Although only one support member 21 is shown in the drawings, it should be understood that several support members 21 are provided within the vehicle 10. Specifically, a portion of at least one of the support members 21 is positioned at the interior side 30 of the vehicle proximate each of one of the accessory mounting members 23.

The diameter D₁ of the apertures 32 in the vehicle body panel 20 is greater than the diameter D₂ of the apertures 36 in the support member 21. Therefore, a portion of the upper surface 37 is not covered by the aperture 32, as is explained in greater detail below.

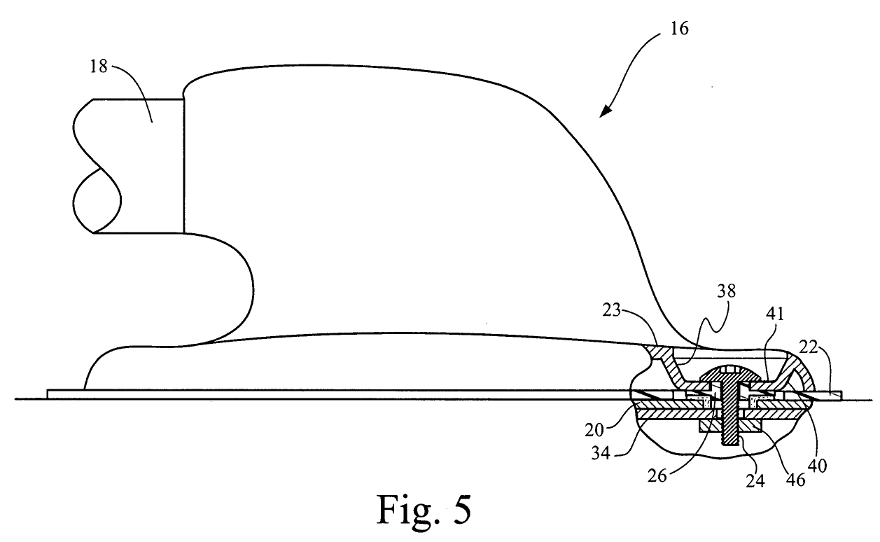

The gasket 22 is typically made of a generally flat pliable sheet-like material, such a rubber or flexible polymer based material. As shown in FIGS. 4 and 5, the gasket 22 is preferably slightly larger than the outer periphery of the accessory mounting member 23 such that the gasket 22 extends slightly outside of the accessory mounting member 23 when installed on the vehicle body panel 20. The gasket 22 limits the ingress of water into the vehicle 10 around the periphery of the accessory mounting member 23, but generally serves to protect the exterior side 28 of the vehicle body panel 20 from possible abrasive contact with the vehicle accessory 12.

The gasket 22 is formed with a plurality of large apertures 39 having a diameter D₃. The large apertures 35 are preferably dimensioned such that the gasket 22 is spaced apart from and does not contact the mounting fastener 24 or the sealing washer 26, as is indicated in FIGS. 4-7.

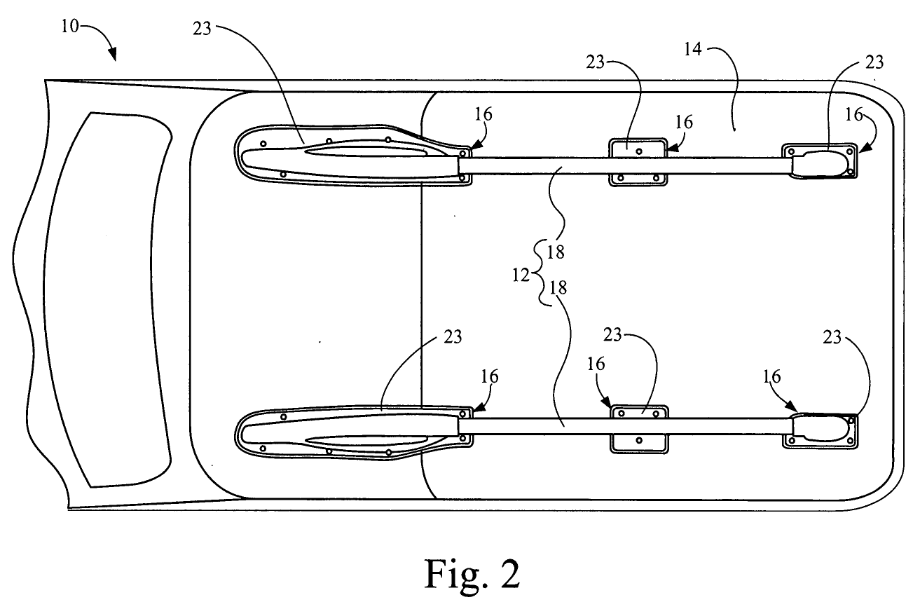

As shown in FIGS. 2-4, the vehicle accessory 12 includes the roof racks 18 that are fixedly attached to the roof structure 14. Each of the roof racks 18 has the accessory mounting members 23, as mentioned above. The accessory mounting members 23 have differing sizes and shapes, but all serve the same function, which is to support the roof racks 18 on the roof structure 14. Since each of the accessory mounting members 23 serves generally the same function, description of only one is included herein for brevity, but applies to all of the accessory mounting members 23, such as the one represented in FIGS. 4 and 5.

As shown in FIGS. 4-7, each of the accessory mounting members 23 basically includes an outwardly facing side 38, a body panel facing side 40 and a plurality of bosses 41. At each of the bosses 41, the accessory mounting members 23 has a thickness T₁, as shown in FIG. 7. The body panel facing side 40 at each of the bosses 41 is preferably spaced apart from the exterior side 28 of the vehicle body panel 20 by a distance SI, as shown in FIG. 6.

A fastener aperture 42 is formed in each boss 41. The fastener aperture 42 extends between the outwardly facing side 38 and the body panel facing side 40. As shown in FIG. 4, the accessory mounting member 23 is provided with a plurality of the fastener apertures 42. The fastening apertures 42 are preferably approximately aligned with the apertures 32 in the vehicle body panel 20 and the apertures 36 in the support member 21, as indicated in FIGS. 5 and 6.

As shown in FIGS. 6 and 7, each of the mounting fasteners 24 is preferably a bolt or similar fastener that includes an exterior retaining portion 44, an interior retaining portion 46 and a shaft portion 48 extending from the exterior retaining portion 44. The exterior retaining portion 44 is disposed on the exterior side 28 of the vehicle body panel 20, and is preferably formed with a lower portion 49, such as a lower surface, and a tool engagement portion 50.

The interior retaining portion 46 is disposed on the interior side 30 of the vehicle body panel 20 is preferably formed with a threaded aperture 52. The interior retaining portion 46 is depicted as a nut in FIG. 4 with the threaded aperture 52. The interior retaining portion 46 can be a separate removable element, or can be fixedly attached to the support member 21 of the vehicle body panel 20. More specifically, the interior retaining portion 46 of the mounting fastener 24 can be welded or otherwise fixedly attached to the support member 21 of the vehicle body panel 20. Alternatively, the interior retaining portion 46 of the mounting fastener 24 can be integrally formed with the support member 21 of the vehicle body panel 20.

The shaft portion 48 of the mounting fastener 24 is preferably machine type threads that releasably engage the threads in the threaded aperture 52 of the interior retaining portion 46 of the mounting fastener 24. The length of the shaft portion 48 defines an axis A (FIG. 7) that defines axial direction of the mounting fastener 24. As indicated in FIGS. 4, 5 and 6, the shaft portion 48 is arranged and configured to extend through: the fastener aperture 42 in the accessory mounting member 23, the sealing washer 26, the aperture 32 in the vehicle body panel 20, the aperture 36 in the support member 21 and finally into the threaded aperture 52 of the interior retaining portion 46 of the mounting fastener 24.

The sealing washers 26 are positioned between the accessory mounting member 23 and the vehicle body panel 20 to provide a water tight seal therebetween. As shown in FIGS. 7 9, each of the sealing washers 26 basically includes a tubular portion 54, a rigid annular flange portion 56, an annular protrusion 58 and a compressible sealing material 60.

The tubular portion 54 of the sealing washer 26 is formed with a hollow interior 62 and an upper end 64. The hollow interior 62 extends from the upper end 64 to the annular protrusion 58. The hollow interior 62 is dimensioned to loosely fit about the shaft portion 48 of the mounting fastener 24. Specifically, hollow interior 62 of the tubular portion 54 has an inner diameter that is slightly larger than the outer diameter of the shaft portion 48 of the mounting fastener 24. As such, the shaft portion 48 freely extends through the hollow interior 62 of the tubular portion 54 once installed, but can undergo only limited lateral movement (if any) with respect to the mounting fastener 24, with the mounting fastener 24 is a loosened condition.

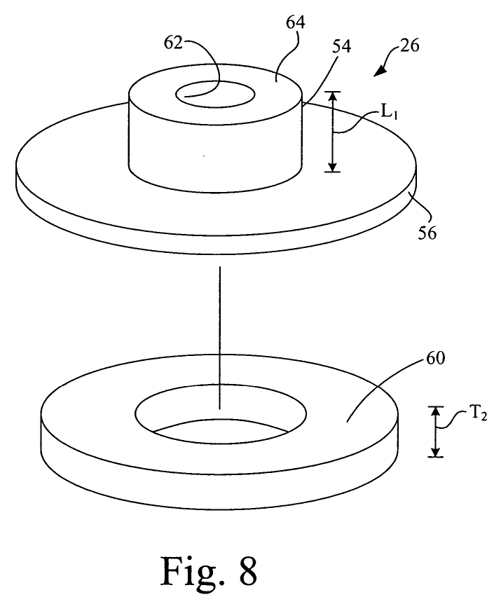

The tubular portion 54 has an axial length L₁ measured along the axial direction of the axis A, as shown in FIGS. 7 and 8. As a result, the upper end 64 is spaced apart from the rigid annular flange portion 56 of the sealing washer 26 by the axial length L₁. The axial length L₁ is preferably the same or slightly larger than the thickness T₁ of the boss 41 of the accessory mounting member 23.

The rigid annular flange portion 56 extends radially outward from the tubular portion 54 and includes a generally flat lower surface 66 that is engaged with the compressible sealing material 60 when the mounting fastener 24 is tightened. The compressible sealing material 60 can be affixed to the flat lower surface 66 or positioned in place during installation.

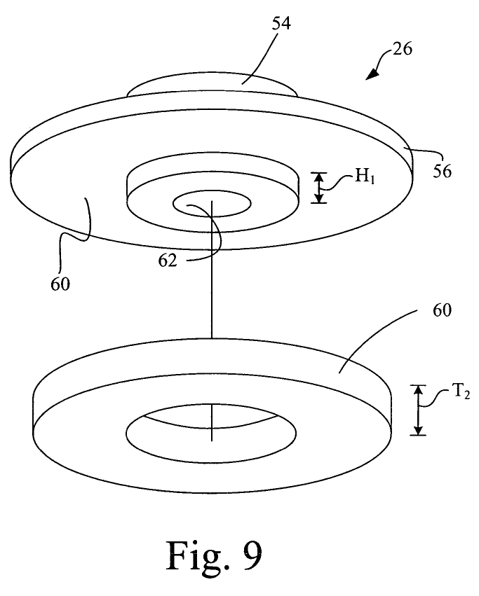

The annular protrusion 58 extends axially away from the flat lower surface 66 of the rigid annular flange portion 56. The annular protrusion 58 extends from the rigid annular flange portion 56 by a height HI that is measured in the axial direction of the axis A of the mounting fastener 24, as shown in FIGS. 7 and 9. When the sealing washer 26 is properly installed, the annular protrusion 58 extends toward vehicle body panel 20 but preferably does not contact the vehicle body panel 20.

The compressible sealing material 60 is preferably made of a thermoset material, such as ethylene propylene diene monomer (EPDM) or other similar sealing material that hardens after installation and compression. Typically, a thermoset material is either fully-cured prior to being installed or cures during natural weathering after installation. In the present invention, the compressible sealing material 60 is installed in either a partially cured or an uncured state such that it undergoes compression and slight deformation prior to fully curing.

The compressible sealing material 60 is preferably formed as an annular disk that is disposed between the vehicle body panel 20 and the rigid annular flange portion 56 of the sealing washer 26 with at least a portion of the compressible sealing material 60 compressed into the aperture 32 (the fastener receiving opening) of the vehicle body panel 20 when the mounting fastener 24 is tightened.

In an uninstalled condition, as shown in FIGS. 7-9, the compressible sealing material 60 has an initial undeformed thickness T₂ measured in the axial direction of the mounting fastener 24. The undeformed thickness T₂ of the compressible sealing material 60 is larger than the axial height HI of the annular protrusion 58. Once installed, and the mounting fastener 24 is tightened, the compressible sealing material 60 is compressed and deforms, as shown in FIG. 6. Specifically, when assembled, the compressible sealing material 60 contacts the exterior side 28 of the vehicle body panel 20. As the mounting fastener 24 is tightened within the threaded aperture 52 of the interior retaining portion 46, the upper end 64 of the tubular portion 54 contacts the lower portion 49 of the exterior retaining portion 44 of the mounting fastener 24.

Tightening of the mounting fastener 24 causes the rigid annular flange portion 56 to press against the compressible sealing material 60. The compressible sealing material 60 is pressed between the rigid annular flange portion 56 and the exterior side 28 of the vehicle body panel 20 forcing the compressible sealing material 60 to deform. At least a portion of the compressible sealing material 60 is urged radially inward toward the shaft portion 48 of the mounting fastener 24. However, the annular protrusion 58 at least partially restricts radially inward deformation of the compressible sealing material 60, causing the compressible sealing material 60 to move downward into the aperture 32 of the vehicle body panel 20. Further compression causes the compressible sealing material 60 to contact and engage the support member 21, as shown in FIG. 6. Contact with the exterior side 28 of the vehicle body panel 20 and the support member 21 ensures that the compressible sealing material 60 can prevent the egress of water from the exterior side 28 of the vehicle body panel 20 into the vehicle 10. Further, since the upper end 64 of the tubular portion of the sealing washer 26 engages the lower portion 49 of the exterior retaining portion 44 of the mounting fastener, the egress of water along the mounting fastener 24 into the vehicle 10 is prevented.

As mentioned above, the axial length L₁ is preferably the same or slightly larger than the thickness T₁ of the boss 41 of the accessory mounting members 23. Once installed, the upper end 64 of the tubular portion 54 of the sealing washer 26 contacts the lower portion 49 of the exterior retaining portion 44 of the mounting fastener 24. With the mounting fastener 24 tightened to engage the upper end 64 of the sealing washer 26, the vehicle accessory 12 can possibly move slightly without affecting the sealing capabilities of the sealing washer 26. However, it is preferable to have the vehicle accessory 12 remain stationary with respect to the mounting fastener 24. The distance S₁ between the body panel facing side 40 of the boss 41 and the vehicle body panel 20 is preferably generally constant. It may be possible for water to invade the space between the mounting fastener 24 and the boss 41, but that water is prevented from entering the vehicle 10 by the sealing configuration of the sealing washer 26 contacting the vehicle body panel 20 and the support member 21.

As should be understood from the drawings and the description herein, the tubular portion 54 of the sealing washer 26 is under compression exerted by the mounting fastener 24. However, it is desirable to avoid plastic deformation of the tubular portion 54 of the sealing washer 26 thereby avoiding plastic creep which can adversely affect the sealing capabilities of the vehicle accessory mounting structure 16. Therefore, the difference between the axial length L₁ and the thickness T₁ of the boss 41 (if any) is determined accordingly to minimize the possibility of damage to the sealing washer 26.

It should be understood by those skilled in the art from this disclosure, that the fastening apertures 42 in the accessory mounting members 23, the apertures 32 in the vehicle body panel 20 and the apertures 36 in the support members 21 are not always in perfect alignment due to manufacturing tolerances. For instance, the apertures 36 in the support member 21 need not be perfectly centered under the apertures 32 in the vehicle body panel 20. However, as long as a portion of the upper surface 37 of the support member 21 is exposed along the entire circumferential periphery of the aperture 32 in the vehicle body panel 20 and the compressible sealing material 60 makes complete annular contact with the upper surface 37, a reliable seal is established.

### Second Embodiment

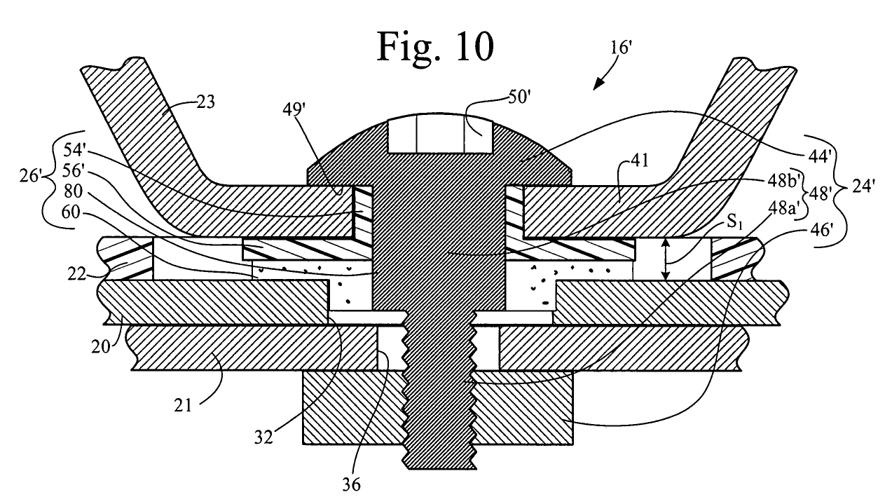

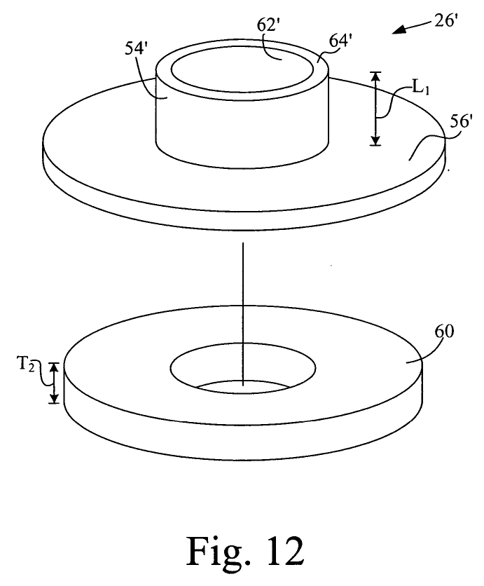

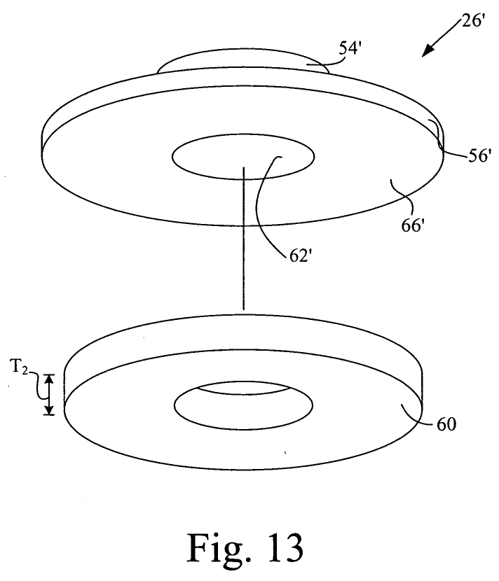

Referring now to FIGS. 10-13, a vehicle accessory mounting structure 16′ in accordance with a second embodiment will now be explained. As explained below, the only differences between the first and second embodiments are that the mounting fastener 24 has been replaced with a modified mounting fastener 24′ and the sealing washer 26 has been replaced with a modified sealing washer 26′ in this second embodiment. In view of these similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a single prime (′).

In the second embodiment, the vehicle body panel 20, the gasket 22 and the accessory mounting member 23 are generally the same or identical to the first embodiment. In the second embodiment, the mounting fastener 24′ and the sealing washer 26′ differ from the mounting fastener 24 and the sealing washer 26 of the first embodiment. Therefore, description of the mounting fastener 24′ and the sealing washer 26′ is provided below with emphasis on the differences between the mounting fastener 24 and the sealing washer 26 of the first embodiment and mounting fastener 24′ and the sealing washer 26′ of the second embodiment.

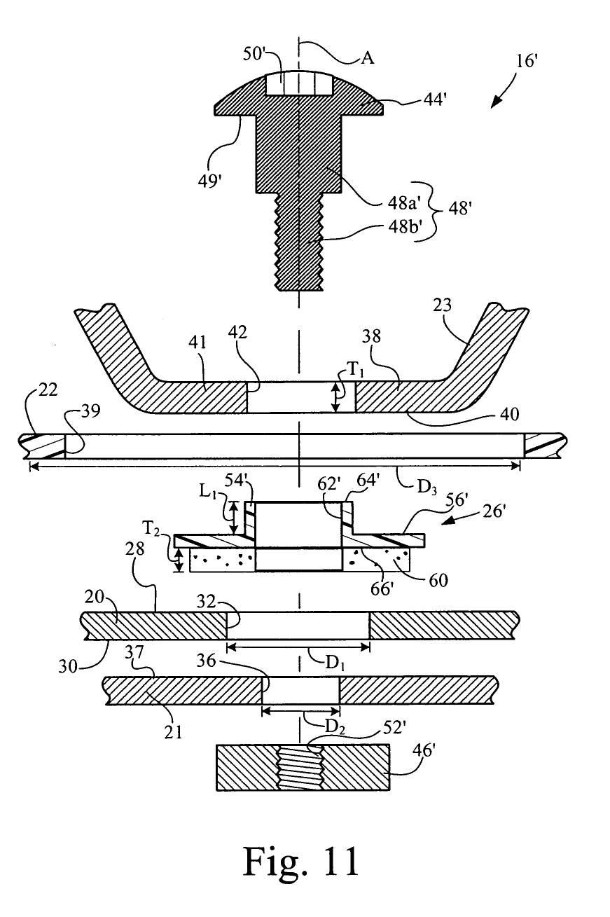

As shown in FIGS. 10 and 11, each of the mounting fasteners 24′ is preferably a bolt or similar fastener that includes an exterior retaining portion 44′, an interior retaining portion 46′ and a shaft portion 48′. The shaft portion 48′ includes a shoulder section 48a′ and a threaded section 48b′. The shoulder section 48a′ extends from the exterior retaining portion 44′ and the threaded section 48b′ extends from the shoulder section 48a′. The exterior retaining portion 44′ is disposed on the exterior side 28 of the vehicle body panel 20, and is preferably formed with a lower portion 49′, such as a lower surface, and a tool engagement portion 50′.

The interior retaining portion 46′ is disposed on the interior side 30 of the vehicle body panel 20 is preferably formed with a threaded aperture 52′. The interior retaining portion 46′ is depicted as a nut in FIG. 11 with the threaded aperture 52′. The interior retaining portion 46′ can be a separate removable element, or can be fixedly attached to the support member 21 of the vehicle body panel 20. More specifically, the interior retaining portion 46′ of the mounting fastener 24′ can be welded or otherwise fixedly attached to the support member 21 of the vehicle body panel 20. Alternatively, the interior retaining portion 46′ of the mounting fastener 24′ can be integrally formed with the support member 21 of the vehicle body panel 20.

The shoulder section 48a′ is an annular rod-shaped portion that is integrally formed with the interior retaining portion 46′ and the threaded section 48b′. As indicated in FIGS. 10 and 11, the shoulder section 48a′ is arranged and configured to extend through the fastener aperture 42 in the accessory mounting member 23, a hollow interior 62′ of the sealing washer 26′ and at least partially through the aperture 32 in the vehicle body panel 20.

The threaded section 48b′ of the mounting fastener 24′ is preferably machine type threads that releasably engage the threads in the threaded aperture 52′ of the interior retaining portion 46′ of the mounting fastener 24′. The length of the threaded section 48b′ and the shoulder section 48a′ defines an axis A (FIG. 11) that defines axial direction of the mounting fastener 24′. As indicated in FIGS. 10 and 11, the threaded section 48b′ is arranged and configured to extend at least partially through the aperture 32 in the vehicle body panel 20, the aperture 36 in the support member 21 and finally into the threaded aperture 52′ of the interior retaining portion 46′ of the mounting fastener 24′.

The sealing washer 26′ is positioned between the accessory mounting member 23 and the vehicle body panel 20 to provide a water tight seal therebetween. As shown in FIGS. 10-13, the sealing washer 26′ basically includes a tubular portion 54′, a rigid annular flange portion 56′, the compressible sealing material 60 (generally the same as in the first embodiment) and an annular tube 80.

The tubular portion 54′ of the sealing washer 26′ is formed with the hollow interior 62′ and an upper end 64′. The hollow interior 62′ extends from the upper end 64′ to a lower surface 66′ of the rigid annular flange portion 56′ but has a larger diameter than the diameter of the hollow interior 62 of the sealing washer 26 of the first embodiment of the present invention. The hollow interior 62′ is dimensioned to fit closely about the shoulder section 48a′, as is described further below.

The tubular portion 54′ has an axial length L₁ measured along the axial direction of the axis A. As a result, the upper end 64′ is spaced apart from the rigid annular flange portion 56′ of the sealing washer 26′ by the axial length L₁. The axial length L₁ is preferably the same or slightly larger than the thickness T₁ of the boss 41 of the accessory mounting members 23.

The rigid annular flange portion 56′ extends radially outward from the tubular portion 54′ and includes the generally flat lower surface 66′ that is engaged with the compressible sealing material 60 when the mounting fastener 24 is tightened. The compressible sealing material 60 can be affixed to the lower surface 66′ or positioned in place during installation.

The shoulder section 48a′ extends through the tubular portion 54′ of the sealing washer 26′. Preferably, the outer diameter of the shoulder section 48a′ is about the same as the inner diameter of the hollow interior 62′ of the tubular portion 54 of the sealing washer 26. As such, the shoulder section 48a′ may undergo axial movement within the tubular portion 54 of the sealing washer 26 in response to force being applied thereto.

When the sealing washer 26′ is properly installed, the shoulder section 48a′ extends toward vehicle body panel 20 but preferably does not contact the vehicle body panel 20.

The compressible sealing material 60 is generally the same as in the first embodiment. As such, the compressible sealing material 60 is preferably formed as an annular disk that is disposed between the vehicle body panel 20 and the lower surface 66′ of the rigid annular flange portion 56′ of the sealing washer 26′.

In an uninstalled condition, as shown in FIGS. 11-13, the compressible sealing material 60 has an initial undeformed thickness T₂ measured in the axial direction of the mounting fastener 24′. The undeformed thickness T₂ of the compressible sealing material 60 is sufficiently thick that upon compression, a portion of the compressible sealing material 60 is forced into contact with the wall of the aperture 32 of the vehicle body panel 20 and the exposed portion of the upper surface 37 of the support member 21.

Tightening of the mounting fastener 24′ causes the rigid annular flange portion 56′ to press against the compressible sealing material 60. The compressible sealing material 60 is pressed between the lower surface 66′ of the rigid annular flange portion 56′ and the exterior side 28 of the vehicle body panel 20 forcing the compressible sealing material 60 to deform. At least a portion of the compressible sealing material 60 is urged radially inward toward the threaded section 48b′ of the mounting fastener 24′. However, the lower end of the shoulder section 48a′ at least partially restricts radially inward deformation of the compressible sealing material 60, causing the compressible sealing material 60 to move downward into the aperture 32 of the vehicle body panel 20. Further compression causes the compressible sealing material 60 to contact and engage the exposed portions of the upper surface 37 of the support member 21, as shown in FIG. 10.

As mentioned above, the axial length L₁ is preferably the same or slightly larger than the thickness T₁ of the boss 41 of the accessory mounting members 23. Once installed, the upper end 64′ of the tubular portion 54′ of the sealing washer 26′ contacts the lower portion 49′ of the exterior retaining portion 44′ of the mounting fastener 24′.

As used herein to describe the above embodiments, the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention. Moreover, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A vehicle accessory mounting structure comprising:
a vehicle body panel having an exterior side and an interior side with a fastener receiving opening extending between the exterior and interior sides;
a mounting fastener having a shaft portion disposed in the fastener receiving opening, an exterior retaining portion disposed on the exterior side of the vehicle body panel and an interior retaining portion disposed on the interior side of the vehicle body panel; and
a sealing washer having a tubular portion disposed about the shaft portion of the mounting fastener, a rigid annular flange portion extending radially from the tubular portion and a compressible sealing material disposed between the vehicle body panel and the rigid annular flange portion with at least a portion of the compressible sealing material being compressed into the fastener receiving opening when the mounting fastener is tightened.

2. The vehicle accessory mounting structure as set forth in claim 1, wherein
the rigid annular flange portion of the sealing washer includes a generally flat lower surface with the compressible sealing material thereon and an annular protrusion that extends axially toward the vehicle body panel from the flat lower surface.

3. The vehicle accessory mounting structure as set forth in claim 2, wherein
the compressible sealing material has an initial undeformed thickness as measured in an axial direction of the fastener that is larger than an axial length of the annular protrusion.

4. The vehicle accessory mounting structure as set forth in claim 1, wherein
the tubular portion of the sealing washer includes an upper end that is spaced from the rigid annular flange portion of the sealing washer by an axial length such that the upper end engages a lower portion of the exterior retaining portion.

5. The vehicle accessory mounting structure as set forth in claim 3, wherein
the upper end of the tubular portion of the sealing washer contacts a lower portion of the exterior retaining portion.

6. The vehicle accessory mounting structure as set forth in claim 1, wherein
the compressible sealing material is made of a curable material that hardens after installation and compression.

7. The vehicle accessory mounting structure as set forth in claim 1, wherein
the rigid annular flange portion of the sealing washer includes a generally flat surface engaged with the compressible sealing material when the mounting fastener is tightened.

8. The vehicle accessory mounting structure as set forth in claim 1, further comprising:
a support member disposed on the interior side of the vehicle body panel, the support member having a fastener aperture with the shaft portion of the mounting fastener extending therein.

9. The vehicle accessory mounting structure as set forth in claim 1, wherein
the shaft portion of the mounting fastener includes a shoulder section and a threaded section, the shoulder section being disposed within the tubular portion of the sealing washer and the threaded section at least partially extending into the vehicle body panel.

10. The vehicle accessory mounting structure as set forth in claim 1, further comprising:
an accessory mounting member with a mounting portion having an outwardly facing side and a body panel facing side with at least one fastener aperture extending between the outwardly facing side and the body panel facing side;
the shaft portion of the mounting fastener extending through the fastener receiving opening.

11. The vehicle accessory mounting structure as set forth in claim 10, wherein
the rigid annular flange portion of the sealing washer includes a generally flat lower surface with the compressible sealing material thereon and an annular protrusion that extends axially toward the vehicle body panel.

12. The vehicle accessory mounting structure as set forth in claim 11, wherein
the compressible sealing material has an initial undeformed thickness as measured in an axial direction of the fastener that is larger than an axial length of the annular protrusion.

13. The vehicle accessory mounting structure as set forth in claim 10, wherein
the tubular portion of the sealing washer includes an upper end that is spaced from the rigid annular flange portion of the sealing washer by an axial length such that the upper end engages a lower portion of the exterior retaining portion.

14. The vehicle accessory mounting structure as set forth in claim 13, wherein
the upper end of the tubular portion of the sealing washer contacts a lower portion of the exterior retaining portion.

15. The vehicle accessory mounting structure as set forth in claim 10, wherein
the compressible sealing material is made of a curable material that hardens after installation and compression.

16. The vehicle accessory mounting structure as set forth in claim 10, wherein
the rigid annular flange portion of the sealing washer includes a generally flat surface engaged with the compressible sealing material when the mounting fastener is tightened.

17. The vehicle accessory mounting structure as set forth in claim 16, further comprising:
a support member disposed on the interior side of the vehicle body panel, the support member having a fastener aperture with the shaft portion of the mounting fastener extending therein.

18. The vehicle accessory mounting structure as set forth in claim 13, wherein
the shaft portion of the mounting fastener includes a shoulder section and a threaded section, the shoulder section being disposed within the tubular portion of the sealing washer and the threaded section at least partially extending into the vehicle body panel.
